(19) United States
(12) Patent Application Publication
(10) Pub. No.: US 2011/0158235 A1
(43) Pub. Date: Jun. 30, 2011

(54) STREAM DELIVERY SYSTEM, CALL CONTROL SERVER, AND STREAM DELIVERY CONTROL METHOD

(76) Inventor: Emi Senga, Hachioji-shi (JP)

(21) Appl. No.: 12/970,769

(22) Filed: Dec. 16, 2010

(30) Foreign Application Priority Data
Dec. 25, 2009 (JP) 2009-296322

(51) Int. Cl. H04L 12/56

(52) U.S. Cl. 370/390

(57) ABSTRACT

According to one embodiment, a stream delivery system includes a plurality of terminals, a call control server and a media server. The media server selectively execute multicast stream delivery and unicast stream delivery according to an instruction from the call control server. The terminal includes a transmitter configured to send the call control server an adjustment request including identification data to identify a media file being reproduced. The call control server comprises a determination module configured to determine whether the media file being reproduced is the unicast stream delivery or multicast stream delivery, based on the identification data included in the adjustment request and a controller configured to request the media server to adjust a stream delivery position.

### CROSS-REFERENCE TO RELATED APPLICATIONS

This application is based upon and claims the benefit of priority from Japanese Patent Application No. 2009-296322, filed Dec. 25, 2009; the entire contents of which are incorporated herein by reference.

### FIELD

Embodiments described herein relate generally to a stream delivery system, which executes multicast or unicast stream delivery of a media file including at least one of picture, voice, and data to a plurality of telephone terminals connected to an Internet Protocol (IP) network, a call control server, and a stream delivery control method.

### BACKGROUND

An IP telephone system configured to make two-way real-time transmission/reception of a picture and voice as packet data through a Local Area Network (LAN) or IP Network has become popular in recent years.

In such an IP telephone system, a media server delivers media signals such as a holding tone and background music (BGM) as a multicast stream. In a multicast stream delivery system, a media server may deliver a less number of streams than that in a system which makes unicast stream delivery for each terminal, and the same media signal can be efficiently delivered to a plurality of terminals.

As an associated technique, there is proposed a telephone system, in which a sound source server transmits a holding tone to a gateway as multicast, and a gateway converts it into unicast and sends it to an external line as unicast (for example, Jpn. Pat. Applin. KOKAI Publication No. 2008-147887).

In the above system, it is justly requested to rewind, halt, and fast-forward a media signal delivered as a multicast stream for playback, as in a common video/DVD/HD (Hard Disk) player. Fast-forward playback is realized when an IP telephone saves and plays back a media signal. In this case, an IP telephone needs a storage area to save a media signal, and the cost of an IP telephone itself is increased.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is a block schematic diagram of a telephone system according to a first embodiment;

FIG. 2 is a block diagram showing a configuration of a call control server shown in FIG. 1;

FIG. 3 is a block diagram showing a configuration of an IP telephone shown in FIG. 1;

FIG. 4 is a diagram showing an example of a sequence of signals when a communication destination of one IP telephone is switched from another IP telephone to a media server for multicast stream delivery in the first embodiment, while two IP telephones are talking with each other;

FIG. 5 is a diagram showing an example of a sequence of signals when an IP telephone performs adjustment of a stream delivery position in the first embodiment, while an IP telephone is reproducing a media file (a holding tone) delivered as a multicast stream;

FIG. 6 is a diagram showing an example of a format of a RTP packet used in the first embodiment;

FIG. 7 is a diagram showing an example of a sequence of signals when an IP telephone adjusts a stream delivery position in the first embodiment, while reproducing a media file (a holding tone) delivered as a unicast stream;

FIG. 8 is a diagram showing an example of a sequence of signals when an IP telephone terminates adjustment of a stream delivery position in the first embodiment;

FIG. 9 is a flowchart of control operation of an IP telephone reproducing advertising information in a second embodiment;

FIG. 10 is a diagram showing a display example of advertising information used in the second embodiment; and

FIG. 11 is a flowchart of control operation of a call control server in the second embodiment.

### DETAILED DESCRIPTION

Various embodiments will be described hereinafter with reference to the accompanying drawings, in general, according to one embodiment, a stream delivery system includes a plurality of terminals, a call control server and a media server. The plurality of terminals connected to a communication network. The call control server executes communication connection between the terminals. The media server selectively execute multicast stream delivery and unicast stream delivery according to an instruction from the call control server, wherein the multicast stream delivery delivers a media file including at least one of picture, voice and data to the terminals connected to the communication network at a time, and wherein the unicast stream delivery delivers the media file to a requesting terminal. wherein the terminal comprises a transmitter configured to send the call control server an adjustment request including identification data to identify a media file being reproduced, when an operation to adjust a stream delivery position is detected, while receiving and reproducing the media file delivered as a stream. Wherein the call control server comprises a determination module configured to determine whether the media file being reproduced is the unicast stream delivery or multicast stream delivery, based on the identification data included in the adjustment request, when the adjustment request is received from the terminal, and a controller configured to request the media server to adjust a stream delivery position, when the decision of the determination module is unicast stream delivery, and requests the media server to deliver another stream, when the decision is multicast stream delivery.

### FIRST EMBODIMENT

FIG. 1 is a block schematic diagram of a telephone system according to a first embodiment. This system has an IP (Internet Protocol) network INW. The IP network INW is connected to a call control server 1, media servers 2-1 to 2-m (m is a natural number), and IP telephone sets 3-1 to 3-n (n is a natural number). Each IP telephone set 3-1 to 3-n has a speech processing function, and a media data processing function.

The call control server 1 has a switching control function to establish a session between IP telephone sets 3-1 to 3-n or between media servers 2-1 to 2-m according to a predetermined protocol such as SIP, MEGACO, and H.323, and a function to request media servers 2-1 to 2-m to send a RTP packet (a medial file) including at least one of recorded picture, voice, and data to IP telephone sets 3-1 to 3-n as a multicast or unicast stream.

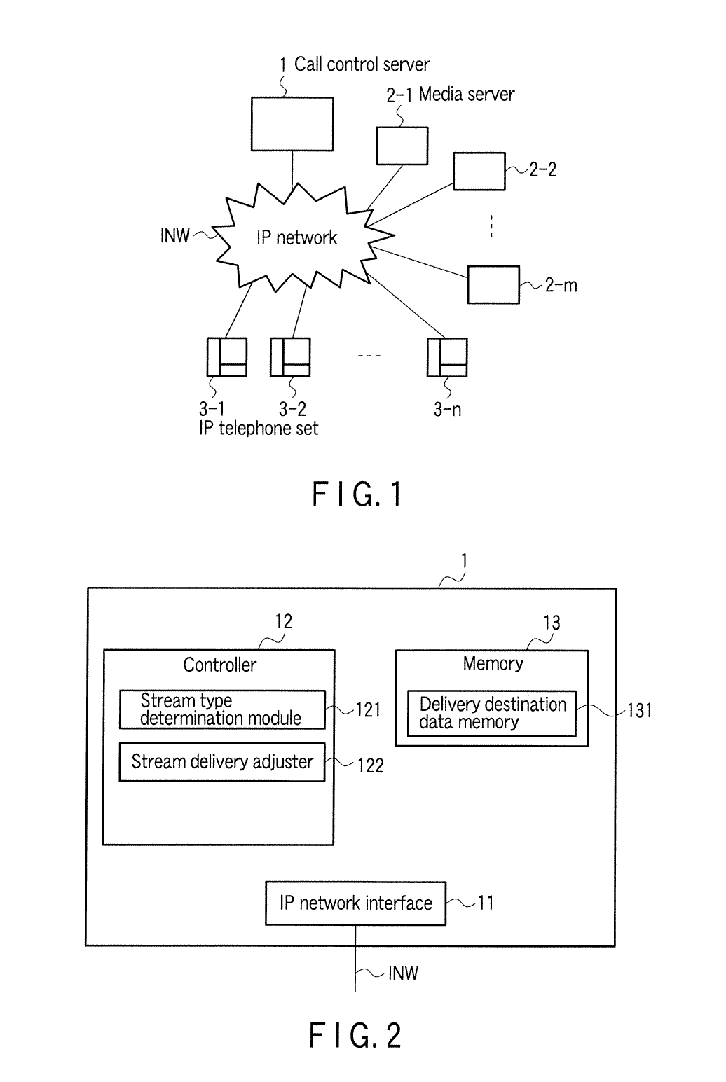

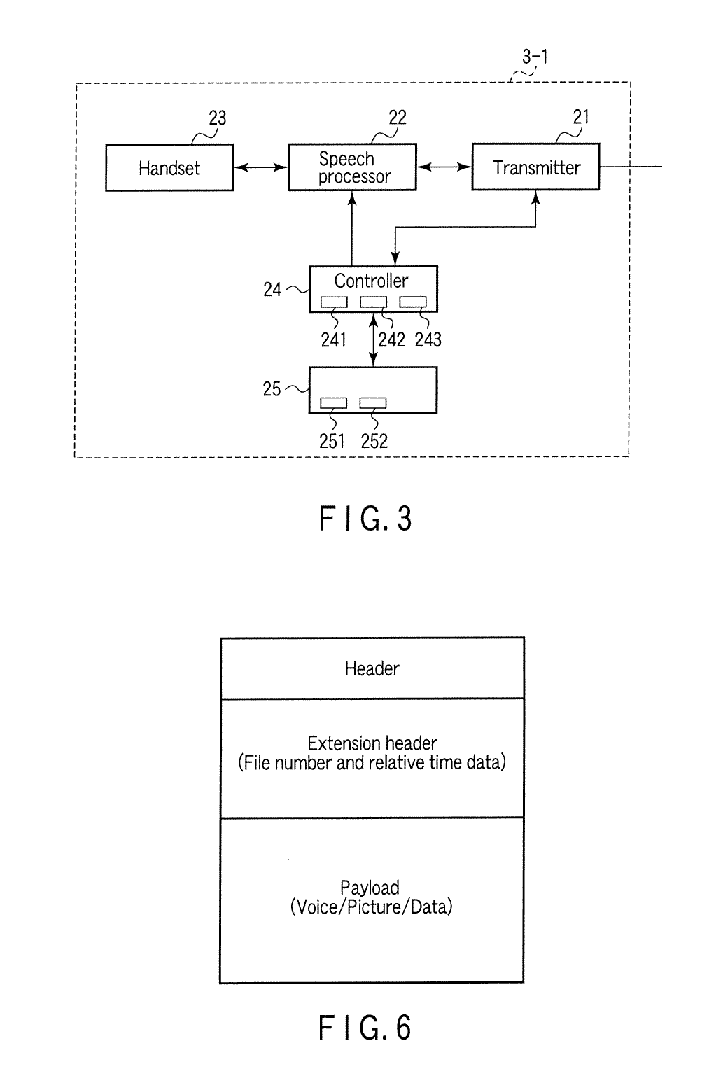

Further, the call control server 1 has the following functions associated with the embodiments. FIG. 2 is a block diagram showing the configuration of the call control server 1.

The call control server 1 comprises an IP network interface 11, a controller 12, and a memory 13. The IP network interface 11 performs interface operation with the IP network INW.

The memory 13 stores routing data necessary for connection control of the controller 12, and has a delivery destination data memory 131.

The delivery destination data memory 131 stores IP addresses and ports of IP telephone sets 3-1 to 3-n to receive a unicast stream.

The controller 12 is provided with a stream type determinator 121 (a determinator 12), and a stream delivery adjuster 122 (an adjuster 122), as another functions associated with the embodiment.

When an adjustment request including identification data to identify a media file in a reproduced RTP packet and stream type data to indicate a reproduced stream is received from the IP telephone set 3-1, for example, the determinator 121 determines whether a reproduced RTP packet is a unicast stream or a multicast stream, based on the identification data and stream type data included in the adjustment request.

When the determination module 121 determines a unicast stream, the adjuster 122 requests the media server 3-2, for example, to adjust a stream delivery position. When the determination module 121 determines a multicast stream, the adjuster 122 requests the media server 3-2 to delivery another stream. For example, a termination request is received from the IP telephone set 3-1 reproducing a unicast stream, the adjuster instructs the media servers 2-1 and 2-2 to switch from a unicast stream to a multicast stream.

The IP telephone sets 3-1 to 3-n have the following functions associated with the embodiment. FIG. 3 is a block diagram showing the configuration of the IP telephone sets 3-1 to 3-n. The IP telephone set 3-1 is explained as a representative.

The IP telephone set 3-1 comprises a transmitter 21, a speech processor 22, a handset 23, a controller 24, and an operation panel 25.

The transmitter 21 swaps various data with an external apparatus by transmission. The transmitter 21 extracts a speech signal and control signal included in a transmission signal sent from the IP network INW, and sends a speech signal to the speech processor 22, and a control signal to the controller 24, respectively. The transmitter 21 generates a transmission signal by time-division multiplexing a serial data signal sent from the speech processor 22 and controller 24, and transmits an obtained signal to the IP network INN.

The speech processor 22 takes out speech data included in a speech signal sent from the transmitter 21, and reproduces a received analog voice signal from the speech data. The speech processor 22 drives a receiver of the handset 23 by the reproduced received voice signal, and outputs the received voice. The speech processor 22 receives a spoken analog voice signal generated by a transmitter of the handset 23. The speech processor 22 converts the spoken voice signal into a speech signal of predetermined form, and sends it to the transmitter 21.

The controller 24 comprises a CPU, a ROM, and a RAM, and controls each part of the telephone set 3-1, and performs data communication with an external apparatus by software processing.

The operation panel 25 comprises a display 251 such as a Liquid Crystal Display (LCD), and a key input module 252. The display 251 displays various data indicating the states of the apparatus output from the controller 24, a telephone directory, and a media file delivered as a stream.

The controller 24 has a media data detector 241, a notice processor 242, and a communication controller 243 as another functions associated with the embodiment.

The media data detector 241 detects media file identification data and relative time data inserted into a RTP extension header of a RTP packet, while receiving and reproducing the RTP packet delivered as a stream.

When the media data detector 241 detects identification data and relative time data, the notice processor 242 displays a detection message together with the identification data and relative time data in the display 251.

The communication controller 243 is configured to communicate with the call control server 1 through the IP network INW, and sends an adjustment request to the call control server 1 according to a stream delivery position adjustment instruction from the key input part 252, and receives data from the call control server 1 as a response to the adjustment request.

Next, operations of the system configured as above will be explained.

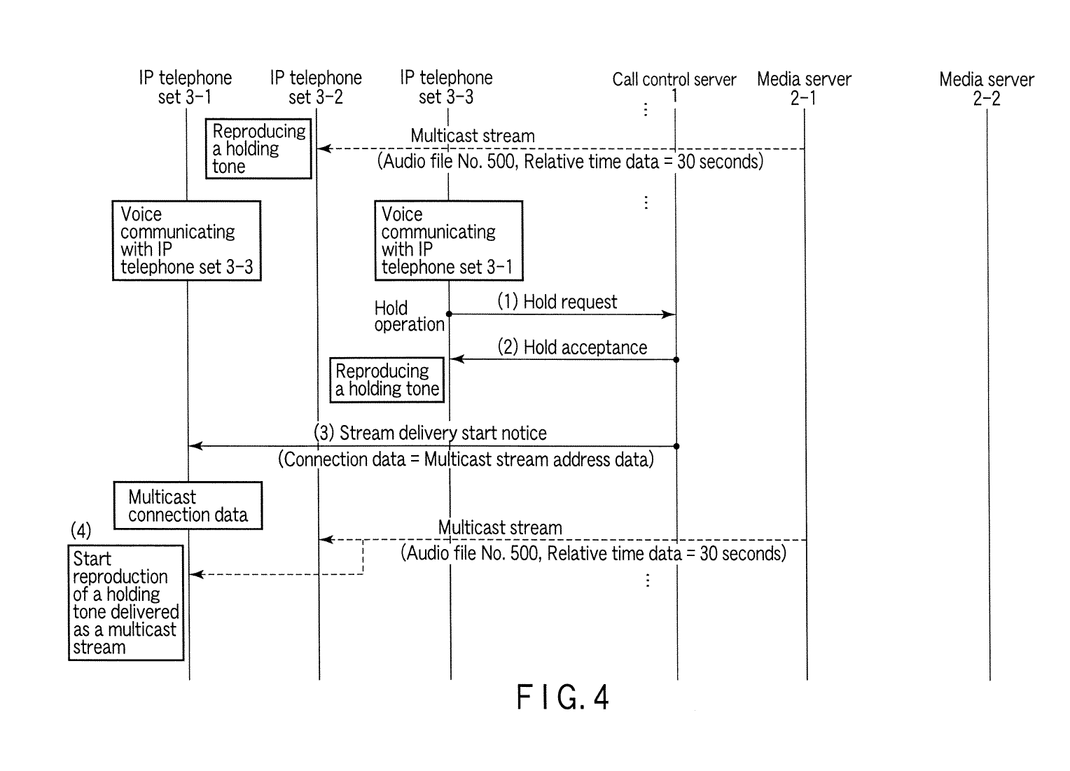

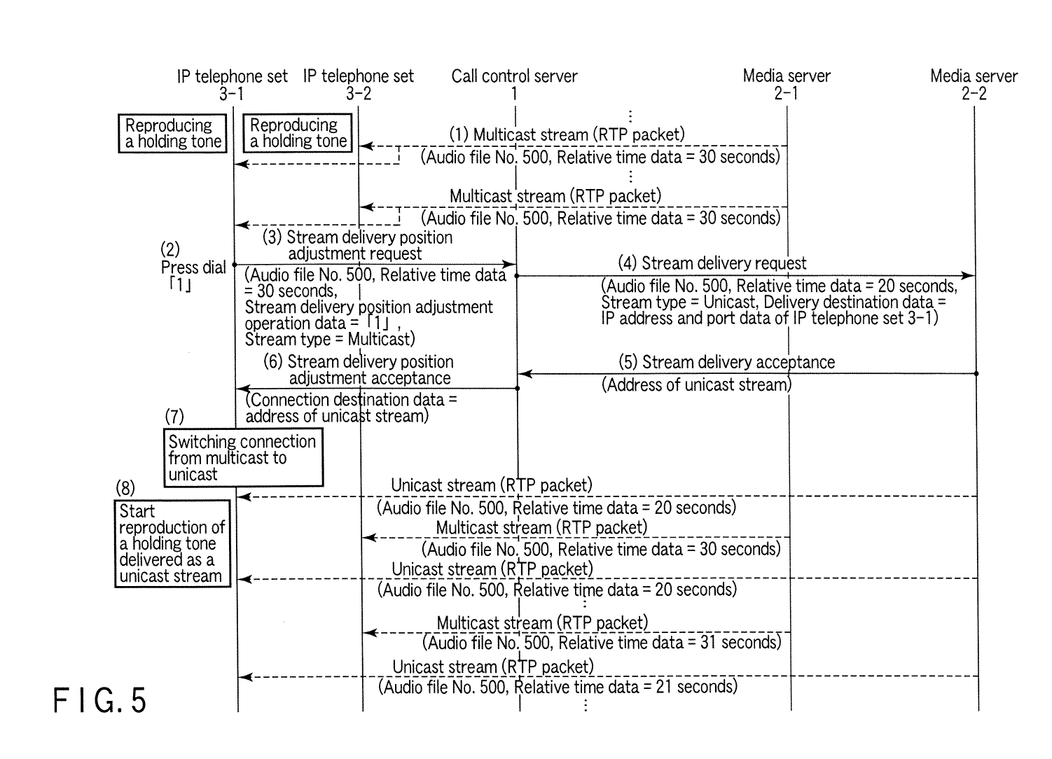

FIG. 4 shows an example of a sequence of signals when a communication destination of the IP telephone set 3-1 is switched from the IP telephone set 3-3 to the media server 2-1 for multicast stream delivery, while the IP telephone sets 3-1 and 3-3 are talking with each other. FIG. 5 shows an example of a sequence of signals when the IP telephone set 3-1 adjusts a stream delivery position, while the IP telephone sets 3-1 and 3-2 are reproducing a media file (a holding tone) delivered as a multicast stream.

For example, it is assumed that the IP telephone sets 3-1 and 3-3 are making voice communication through an extension line as shown in FIG. 4. The IP telephone set 3-2 is assumed to be reproducing a holding tone delivered by the media server 2-1 as a multicast packet.

In this state, if the user holds a call in the IP telephone set 3-3, then the IP telephone set 3-3 sends a “hold request” to the call control server 1 through the IP network INW (FIG. 4 (1)). Receiving the hold request, the call control server 1 sends a “hold acceptance” to the IP telephone set 3-3 (FIG. 4 (2)). The call control server 1 switches a state of communication between the IP telephone sets 3-1 and 3-3 stored in the delivery destination data memory 131, to a holding state, and sends a “stream delivery start” to the IP telephone set 3-1 (FIG. 4 (3)).

The stream delivery start notice includes the address of the multicast stream delivered by the media server 2-1. Receiving the notice, the IP telephone set 3-1 is switched to be able to receive a holding tone packet sent from the media server (FIG. 4 (4)).

In this way, the communication destination of the IP telephone set 3-1 is switched from the IP telephone set 3-3 to the media server 2-1, and thereafter, the users of IP telephone sets 3-1 and 3-2 can hear a holding tone comprising a single tone or more tones sent from the media server 2-1.

As shown in FIG. 5, a holding tone sent from the media server 2-1 is delivered as a RTP packet (FIG. 5 (1)). FIG. 6 shows an example of a RTP packet format used at this time. As shown in FIG. 6, a RTP packet comprises a RTP header, a RTP extension header, and a payload. A destination IP address is inserted into a RTP header, and holding tone data to be reproduced is inserted into a payload. In a RTP extension header, an audio file number of a holding tone and relative time data indicating a holding tone delivery (data indicating elapse time of a delivered packet from an audio file start position) are inserted.

In this embodiment, it is possible to rewind, fast-forward, and halt a holding tone heard by the IP telephone user. For example, in adjustment of a stream delivery position, dialing “1” is to request to reproduce a stream by returning 10 seconds from a current position. Dialing “0” is to terminate adjustment of a stream delivery position. Dialing “3” is to request to reproduce a stream by advancing 10 seconds from a current position.

When the dial “1” of the IP telephone set 3-1 is pressed during reproducing a holding tone delivered as a multicast stream (FIG. 5 (2)), the IP telephone set 3-1 reads an audio file number and relative time data from an extension head of a RTP packet being reproduced. The IP telephone set 3-1 identifies a stream type (multicast) according to whether the destination address is a multicast address or not.

The IP telephone set 3-1 sends a “stream delivery position adjustment request” to the call control server 1 (FIG. 5 (3)). A stream delivery position adjustment request includes an audio file number, relative time data, stream delivery position adjustment operation data (dial “1”), and a stream type (multicast or unicast). Stream delivery position adjustment operation is called operation data in the following description.

Hereinafter, an explanation will be given of a case where a call control server 1 receives a multicast stream from a media server, and a case where a call control server 1 receives a unicast stream from a media server.

First, an explanation is given on the case where a RTP server receives a multicast stream.

Receiving a stream delivery position adjustment request, the call control server 1 first determines that a stream type is multicast. In case of multicast delivery, a stream is usually delivered to a plurality of IP telephone sets 3-1 to 3-n, and it is impossible to rewind, fast forward, and stop a stream in response to a stream delivery position adjustment request from one user. Thus, the call control server 1 reserves a resource for another media server, and delivers another holding tone as a unicast stream to an IP telephone sending a stream delivery position adjustment request in response to the stream delivery position adjustment request. For the simplicity of explanation, a resource is reserved for the media server 2-2 in this embodiment. A resource for unicast delivery is not necessarily reserved for another server, and another resource of the same server may be used.

The call control server 1 sends a “stream delivery request” to the media server 2-2 to start another stream delivery (FIG. 5 (4)). At this time, a delivery position included in the stream delivery request shall be a value decreased 10 seconds from relative time data (because, the operation data is “1”).

Receiving the stream delivery request, the media server 2-2 sends a “stream delivery acceptance” to the call control server 1, and starts unicast stream delivery to the IP telephone set 3-1 (FIG. 5 (5)).

Receiving the “stream delivery acceptance”, the call control server 1 sends a “stream delivery position adjustment acceptance” to the IP telephone set 3-1 (FIG. 5 (6)).

Receiving the “stream delivery position adjustment acceptance”, the IP telephone set 3-1 switches the connection of a holding tone from multicast delivery from the media server 2-1 to unicast delivery from the media server 2-2 (FIG. 5 (7)). Thereafter, in the IP telephone set 3-1, a holding tone returned 10 seconds from depression of the dial “1” is reproduced ((FIG. 5 (8)).

When the dial “3” for fast-forwarding a holding tone is pressed, the call control server 1 sends a “stream delivery request” to the media server 2-2 to start another stream delivery, by increasing a delivery position 10 seconds from relative time data. Thereafter, in the IP telephone set 3-1, a holding tone delivered from the media server 2-2 is reproduced by advancing 10 seconds from depression of the dial “3”.

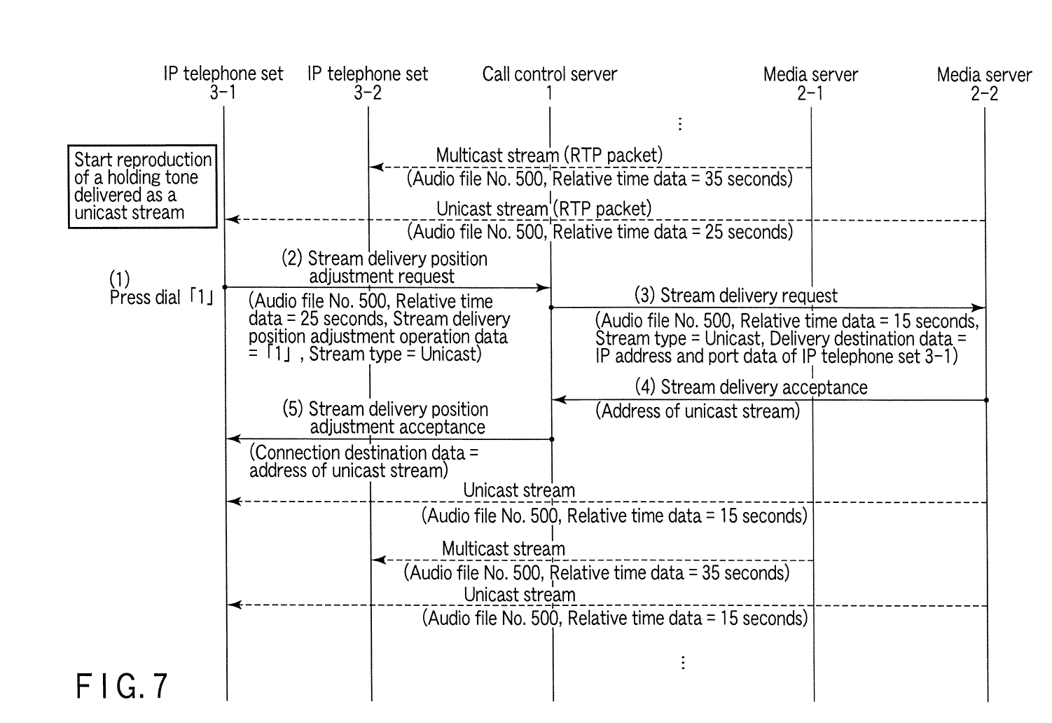

FIG. 7 shows an example of a sequence of signals when the IP telephone set 3-1 adjusts a stream delivery position, while reproducing a media file (a holding tone) delivered as a unicast stream.

When the dial “1” of the IP telephone set 3-1 is pressed while reproducing a holding tone delivered as a unicast stream (FIG. 7 (1)), the IP telephone set 3-1 reads an audio file number and relative time data from an extension header of a RTP packet being reproduced. The IP telephone set 3-1 identifies a stream type (unicast) according to whether the destination address is a multicast address or not.

The IP telephone set 3-1 sends a “stream delivery position adjustment request” to the call server 1 (FIG. 7 (2)). A “stream delivery position adjustment request” includes an audio file number, relative time data, operation data (dial “1”), and a stream type (unicast).

Receiving the “stream delivery position adjustment request”, the call control server 1 determines that the stream type is unicast. Unicast delivery is originally for a specific user, and a delivery position can be adjusted according to the “stream delivery position adjustment request”. Therefore, unlike multicast delivery, a resource for another media server is unnecessary, and a delivered holding tone can be rewound, fast-forwarded, and stopped according to the received position adjustment request.

The call control server 1 sends a “stream delivery request” to the media server 2-2 for adjustment of a stream delivery position in the IP telephone set 3-1 (FIG. 7 (3)). At this time, a delivery position included in the “stream delivery request” shall be a value decreased 10 seconds from relative time data (because, the operation data is “1”).

Receiving the stream delivery request, the media server 2-2 sends a “stream delivery acceptance” to the call control server 1 (FIG. 7 (4)), and changes the contents of a media file to be delivered as a unicast stream to the IP telephone set 3-1.

Receiving the stream delivery acceptance, the call control server 1 sends a “stream delivery position adjustment acceptance” to the IP telephone set 3-1 (FIG. 7 (5)).

Receiving the “stream delivery position adjustment acceptance”, the IP telephone set 3-1 does not switch the connection, because the connection destination is not changed. As the media server 2-2 changes the stream delivery contents, in the IP telephone set 3-1, a holding tone returned 10 seconds from depression of the dial “1” is reproduced.

When the operation data “3” for fast-forwarding a holding tone is pressed, the call control server 1 sends a “stream delivery request” to the media server 2-2 executing unicast delivery, by increasing a delivery position 10 seconds from relative time data.

Thereafter, in the IP telephone set 3-1, a holding tone delivered from the media server 2-2 is reproduced by advancing 10 seconds from depression of the dial “3”.

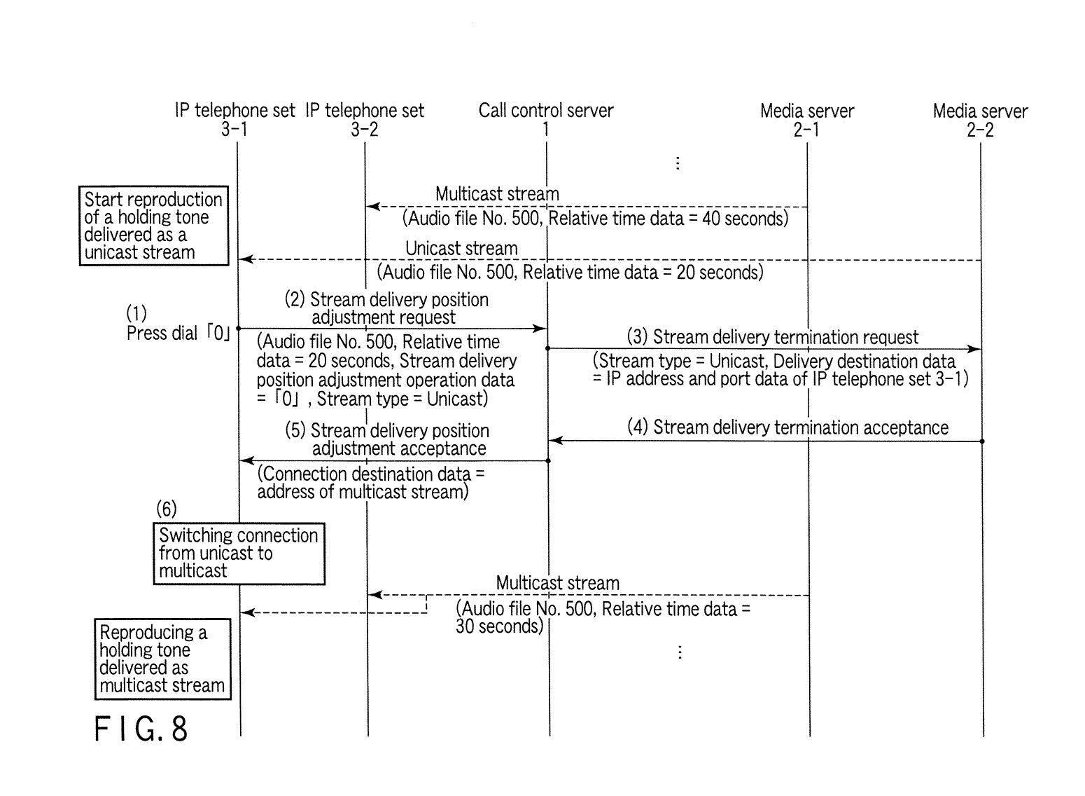

FIG. 8 shows an example of a sequence of signals when the IP telephone set 3-1 terminates adjustment of a stream delivery position.

When the dial “0” of the IP telephone set 3-1 is pressed while reproducing a holding tone delivered as a unicast stream (FIG. 8 (1)), the IP telephone set 3-1 reads an audio file number and relative time data from an extension header of a RTP packet being reproduced. The IP telephone 3-1 identifies a stream type (unicast) according to whether the destination address is a multicast address or not.

The IP telephone set 3-1 sends a “stream delivery position adjustment request” to the call control server 1 (FIG. 8 (2)). A “stream delivery position adjustment request” includes an audio file number, relative time data, operation data (dial “0”), and a stream type (unicast).

Receiving the “stream delivery position adjustment request”, the call control server 1 determines that the stream type is unicast, because the operation data is “0”. The call control server 1 sends a “stream delivery termination request” to the media server 2-2 to terminate the unicast stream delivery to the IP telephone set 3-1 (FIG. 8 (3)).

Receiving the “stream delivery termination request”, the media server 2-2 sends a “stream delivery termination acceptance” to the call control server 1, and terminates the unicast stream delivery to the IP telephone set 3-1 (FIG. 8 (4)).

Receiving the “stream delivery termination acceptance”, the call control server 1 sends a “stream delivery position adjustment acceptance” to the IP telephone set 3-1 (FIG. 8 (5)).

Receiving the “stream delivery position adjustment acceptance”, the IP telephone set 3-1 changes the connection from unicast to multicast according to the connection destination data (FIG. 8 (6)). Thereafter, in the IP telephone set 3-1, a holding tone delivered as a multicast stream is reproduced.

As described above, in the first embodiment, while the IP telephone set 3-1 is reproducing a holding tone delivered as a multicast stream, another stream delivery is started only for the IP telephone set 3-1 which adjusted a stream delivery position, without stopping the multicast stream delivery. Therefore, compared with a system which delivers a unicast stream to each IP telephone set 3-1 to 3-n, efficient stream delivery is possible by effectively using a limited band on the IP network INW. Therefore, an occupied band on the IP network INW is not increased, and efficient stream delivery is possible.

The IP telephone sets 3-1 to 3-n need not to have a storage area to save a media file, and an expensive IP telephone set is unnecessary. This reduces the whole system cost.

Further, in the first embodiment, the IP telephone set 3-1 can request the call control server to adjust a stream delivery position by using identification data and related time data included in an RTP extension header of a RTP packet delivered from the media server 2-1. This eliminates the necessity of providing a signal for sending identification data and relative time data of a media file, and simplifies the configuration.

The call control server 1 can determine a unicast stream delivery when an IP address and port for stream delivery assigned to a requesting IP telephone set 3-1 are stored in the delivery destination data memory 131.

### SECOND EMBODIMENT

A second embodiment shows an example of multicast delivery of advertising information to standby IP telephone sets 3-1 to 3-n.

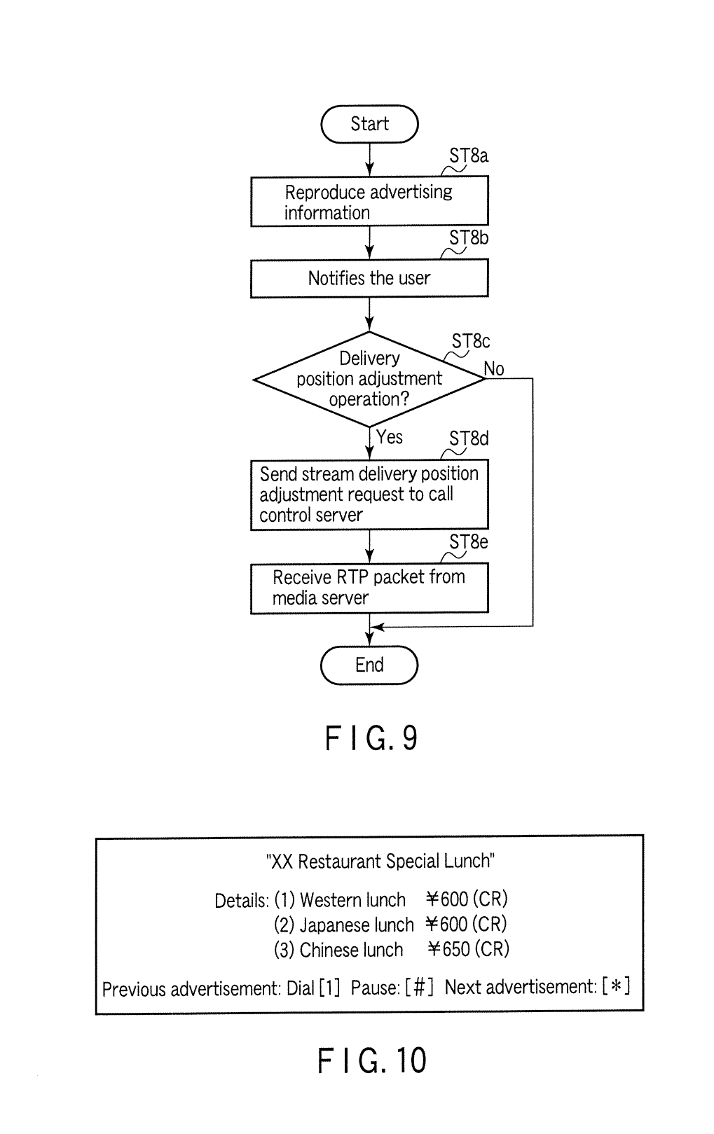

FIG. 9 is a flowchart of control operation of an IP telephone set 3-1 reproducing advertising information.

A media server 2-3 sends each IP telephone set 3-1 to 3-n a RTP packet including a file number of advertising information and relative time data indicating a delivery position, as a multicast stream. The IP telephone set 3-1 reproduces the advertising information from the RTP packet delivered from the media server 2-3 (block ST8a), and supplies the reproduced advertising information to the display 251 to display it on an On Screen Display (OSD), as shown in FIG. 10 (block ST8b).

When the user instructs to view previous advertisement from a key input part (presses the dial “1”) in this state, the IP telephone set 3-1 moves from block ST8c to block ST8d, and sends a stream delivery position adjustment request to the call control server 1. A stream delivery position adjustment request includes a file number, relative time data, operation data (dial “1”, and a stream type (multicast).

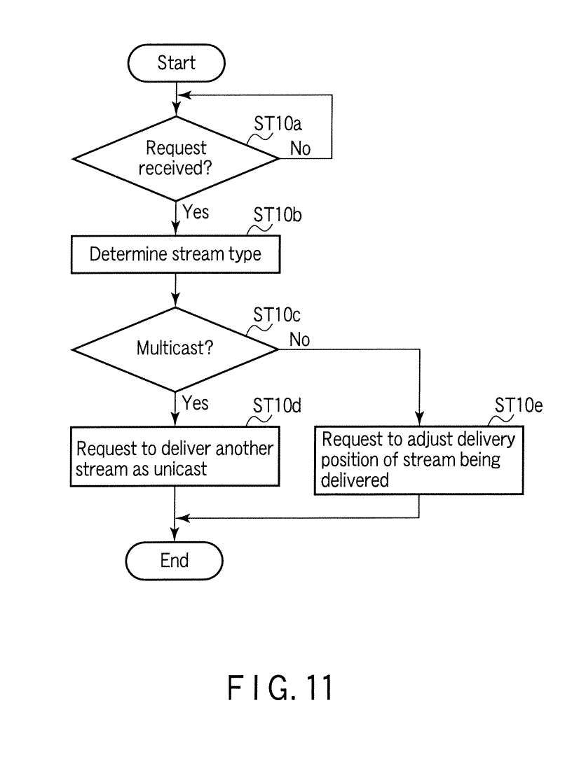

FIG. 11 is a flowchart of control operation of the call control server 1.

The call control server 1 monitors arrival of a stream delivery position adjustment request from each IP telephone set 3-1 to 3-n in block ST10a. When a stream delivery position adjustment request is received from the IP telephone set 3-1, the call control server 1 determines a type of the stream being reproduced in the IP telephone set 3-1, based on the file number and stream type included in the adjustment request (block ST10b).

When the stream being reproduced is a multicast stream, the call control server 1 moves from block ST10c to block ST10d, and sends a stream delivery request to the media server 2-4, for example, to start another stream delivery. At this time, the delivery position data included in the stream delivery request shall be a value indicating the number of advertisement one before the relative time data (because, the operation data is “1”).

Receiving the stream delivery request, the media server 2-4 sends a stream delivery acceptance to the call control server, and starts unicast stream delivery to the IP telephone set 3-1.

Receiving the stream delivery acceptance, the call control server 1 sends a stream delivery position adjustment acceptance to the IP telephone set 3-1.

Receiving the stream delivery position adjustment acceptance, the IP telephone set 3-1 switches the connection destination from the media server 2-3 for multicast delivery to the media server 2-4 for unicast delivery. Therefore, in the IP telephone set 3-1, advertising information one before depression of the dial “1” is reproduced (block ST8e).

When the delivery is unicast in block ST10c, the call control server 1 moves from block ST10c to block ST10e, and sends a stream delivery request to a delivered server (for example, the media server 2-4).

Receiving the stream delivery request, the media server 2-4 sends a “stream delivery acceptance” to the call control server 1, and changes the contents of advertising information to be delivered as a unicast stream to the IP telephone set 3-1.

Receiving the stream delivery acceptance, the call control server 1 sends a stream delivery position adjustment acceptance to the IP telephone set 3-1.

Receiving the stream delivery position adjustment acceptance, the IP telephone set 3-1 does not change the connection, because the connection destination data is not changed. As the media server 2-4 changes the stream delivery contents, in the IP telephone set 3-1, advertising information one before depression of the dial “1” is reproduced.

When the user instructs to view the next advertisement (press the dial “*”) in block ST8c, the IP telephone set 3-1 sends the call control server 1 a stream delivery position adjustment request including a file number, relative time data, operation data (dial “*”), and a stream type (multicast), and reproduces the next advertising information to be delivered from the media server 2-5, for example.

When the user instructs to pause (press the dial “#”) in block ST8c, the IP telephone set 3-1 sends the call control server 1 a stream delivery position adjustment request including a file number, relative time data, operation data (dial “#”) and a stream type (multicast), and reproduces a still image of advertisement delivered from the media server 2-6, for example, when the dial “#” is pressed.

As described above, in the second embodiment, as in the first embodiment, while the IP telephone set 3-1 is reproducing advertising information delivered as a multicast stream, another stream delivery is started only for the IP telephone set 3-1 which adjusted a stream delivery position, without stopping the multicast stream delivery. Therefore, compared with a system which delivers a unicast stream to each IP telephone set 3-1 to 3-n, efficient stream delivery is possible by effectively using a limited band on the IP network INW. Therefore, an occupied band on the IP network INW is not increased, and efficient stream delivery is possible.

### THIRD EMBODIMENT

A third embodiment shows an example of changing from unicast stream delivery to multicast stream delivery when a tune played back is finished. In the first and second embodiments, unicast stream delivery is switched to multicast stream delivery, when a unicast termination request is received from an IP telephone which reproduces a file delivered as a unicast stream. A reproduction file delivered as a unicast stream from the media server 2-2 is not limited to a holding tone, and can be used as BGM. Hold time is relatively short for a holding tone, and no problem occurs. However, in case of BGM, playback time is long, and when the user of each IP telephone set 3-1 to 3-n executes “stream delivery position adjustment”, a resource is reserved for another media server every time the adjustment is executed, and the resource may be exhausted.

Thus, in the third embodiment, unicast stream delivery is switch to multicast stream delivery, when playback of a tune is finished. Since elapse time from the beginning of a tune is different depending on the stream delivery position adjusted by the user, a time lag occurs when unicast stream delivery is switched to multicast stream delivery. If a stream is switched at the end of a tune, the user feels uncomfortable. By switching a unicast stream to a multicast stream at the end of a tune, a beginning part of the next tune lacks, but it is less uncomfortable than switching during playback of a tune.

As a configuration to realize switching from a unicast stream to a multicast stream, the media server 2-2 sends a unicast stream with data indicating the end of a tune included in an extension header. Receiving the unicast stream, the IP telephone set 3-1, for example, requests the call control server 1 to switch to the media server 2-2. Receiving the request to switch to the media server 2-2, the call control server 1 returns a switching destination to the IP telephone set 3-1. This response includes the address of a multicast stream delivered by the media server 2-1, for example. Receiving the response from the call control server 1, the IP telephone set 3-1 switches to a multicast stream. The call control server 1 sends a control signal to stop sending to the media server 2-2 delivering a unicast stream. Receiving the control signal to stop sending, the media server 2-2 stops delivery, and releases the resource.

As described above, the media server resource can be saved by stopping delivery of a unicast stream at the end of a tune, and switching to a multicast delivery.

Switching from a unicast stream to a multicast stream is not limited at the end of a tune. The media server resource can be saved by switching at the beginning or middle of a tune. A unicast stream may be switched to a multicast stream after a lapse of predetermined delivery time. In this case, the time of switching from a multicast stream to a unicast stream is previously stored in the delivery destination memory 131 stored in the call control server 1, and after a lapse of predetermined time, the call controller sends the IP telephone set 3-1, for example, a control signal for switching from a unicast stream to a multicast stream. Receiving a response from the IP telephone set 3-1, the call controller sends a control signal to stop sending to the media server 2-2 delivering a unicast stream. Receiving the control signal to stop sending, the media server 2-2 stops delivery, and releases the resource.

In the above way, efficient stream delivery is possible without using a band (resource) for unicast stream delivery for a long time.

### OTHER EMBODIMENTS

The embodiments are not limited to those described herein. For example, in the embodiments described herein, file identification data and relative time data are included in an extension header of a RTP packet delivered from a media server. However, if a call control server manages a file during delivery, rewind or fast-forward reproduction is possible for a file to which identification data and relative time data are not added.

Further, a system configuration, a functional configuration of a call control server, an IP telephone configuration, a type of media file to be delivered, and a stream delivery position adjustment method may be embodied in other specific forms without departing from the spirit and essential characteristics.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A stream delivery system comprising:
a plurality of terminals connected to a communication network;
a call control server configured to execute communication connection between the terminals; and
a media server configured to selectively execute multicast stream delivery and unicast stream delivery according to an instruction from the call control server, wherein the multicast stream delivery delivers a media file including at least one of picture, voice and data to the terminals connected to the communication network at a time, and wherein the unicast stream delivery delivers the media file to a requesting terminal,
wherein the terminal comprises a transmitter configured to send the call control server an adjustment request including identification data to identify a media file being reproduced, when an operation to adjust a stream delivery position is detected, while receiving and reproducing the media file delivered as a stream, and
the call control server comprises a determination module configured to determine whether the media file being reproduced is the unicast stream delivery or multicast stream delivery, based on the identification data included in the adjustment request, when the adjustment request is received from the terminal, and
a controller configured to request the media server to adjust a stream delivery position, when the decision of the determination module is unicast stream delivery, and requests the media server to deliver another stream, when the decision is multicast stream delivery.

2. The stream delivery system of claim 1, wherein the media server comprises a notifying module configured to notify identification data to identify a media file to be delivered, and relative time data indicating a delivery position of the media file, by adding the data to the media file, when executing stream delivery,
the terminal further comprises a detector configured to detect the identification data and relative time data added to the media file, while receiving and reproducing the media file delivered as a stream, and
the transmitter notifies the user of the result of detection by the detector, and sends the call control server an adjustment request including the identification data and relative time data, when the user adjusts a stream delivery position in response to the notice.

3. The stream delivery system of claim 2, wherein the notifying module notifies the terminal of the identification data and relative time data by inserting the identification data and relative time data into an extension header, when the media file takes a Real-time Transport Protocol (RTP) packet structure, and
the detector reads the identification data and relative time data from the RTP extension header of the RTP packet.

4. The stream delivery system of claim 1, wherein the transmitter sends the call control server an adjustment request including the identification data, relative time data, and stream type data indicating the type of a stream being, and
the determination module determines whether a media file being reproduced is the unicast stream delivery or multicast stream delivery, based on the identification data and stream type data included in the adjustment request.

5. The stream delivery system of claim 1, wherein the determination module determines whether a media file being reproduced is the unicast stream delivery or multicast stream delivery, based on connection destination data for stream delivery of a terminal sending the adjustment request.

6. The stream delivery system of claim 1, wherein the controller instructs the media server to switch from the unicast stream delivery to the multicast stream delivery based on a predetermined condition, when the terminal which sends the adjustment request is receiving a unicast stream.

7. The stream delivery system of claim 6, wherein the controller uses at least one of delivery time, the media file contents, and a termination request from the terminal, for determining a condition.

8. A call control server executing communication connection between a plurality of terminals connected to a communication network, and selectively making a media server execute multicast stream delivery and unicast stream delivery, wherein the media server is connected to the communication network, wherein the multicast stream delivery delivers a media file including at least one of picture, voice and data to the terminals connected to the communication network at a time, and wherein the unicast stream delivery delivers the media file to a requesting terminal, the call control server comprising:
a determination module configured to determine whether a media file being reproduced is the unicast stream delivery or multicast stream delivery, based on identification data included in an adjustment request, when the adjustment request is received from the terminal, wherein the adjustment request includes identification data to identify a media file being reproduced, and
a controller configured to request the media server to adjust a stream delivery position, when the decision of the determinator is unicast stream delivery, and request the media server to deliver another stream, when the decision of the determinator is multicast stream delivery.

9. The call control server of claim 8, wherein the determination module determines whether a media file being reproduced is the unicast stream delivery or multicast stream delivery, based on the identification data and stream type data, when the adjustment request includes stream type data indicating the type of a stream being delivered.

10. The call control server of claim 8, wherein the determination module determines whether a media file being reproduced is the unicast stream delivery or multicast stream, based on connection destination data for stream delivery of a terminal sending the adjustment request.

11. The call control server of claim 8, wherein the controller instructs the media server to switch from the unicast stream delivery to the multicast stream delivery based on a predetermined condition, when the terminal which sends the adjustment request is receiving a unicast stream.

12. The call control server of claim 11, wherein the controller uses at least one of delivery time, the media file contents, and a termination request from the terminal, for determining a condition.

13. A stream delivery control method used in a call control server executing communication connection between a plurality of terminals connected to a communication network, and making a media server selectively execute multicast stream delivery and unicast stream delivery, wherein the media server is connected to the communication network, wherein the multicast stream delivery delivers a media file including at least one of picture, voice and data to the terminals connected to the communication network at a time, and wherein the unicast stream delivery delivers the media file to a requesting terminal, the stream delivery control method comprising:
determining whether a media file being reproduced is the unicast stream delivery or multicast stream delivery, based on identification data included in an adjustment request including identification data to identify a media file being reproduced, when the adjustment request is received from the terminal, and
requesting the media server to adjust a stream delivery position, when the decision of the determinator is unicast stream delivery, and requests the media server to deliver another stream, when the decision is multicast stream delivery.
